(19) United States
(12) Patent Application Publication
(10) Pub. No.: US 2013/0311247 A1
(43) Pub. Date: Nov. 21, 2013

(54) System for Supplying Power to an Electric Vehicle on a Parking Space

(71) Applicants: Clemens Wass, Salzburg (AT); Bertrand Wendling, Divonne-Les-Bains (FR)

(72) Inventors: Clemens Wass, Salzburg (AT); Bertrand Wendling, Divonne-Les-Bains (FR)

(73) Assignee: SKIDATA AG, Groedig/Salzburg (AT)

(21) Appl. No.: 13/838,866

(22) Filed: Mar. 15, 2013

Related U.S. Application Data
(63) Continuation-in-part of application No. 12/803,311, filed on Jun. 24, 2010, now abandoned.

(30) Foreign Application Priority Data
Jul. 8, 2009 (EP) 09008897.2

(51) Int. Cl. G06Q 20/14

(52) U.S. Cl. CPC G06Q 20/145
USPC 705/13; 705/40

(57) ABSTRACT

A system is proposed for supplying power to an electric vehicle on a parking space, which system has, for each parking space or for a group of parking spaces, a charging station which is assigned to the parking space or the group of parking spaces and which comprises means for supplying power to the electric car, for detecting the consumed power, for identifying or detecting the vehicle for the purpose of billing for the consumed power, and a device for paying for the consumed power.

### CROSS REFERENCE TO RELATED APPLICATIONS

This application is a continuation-in-part of co-pending U.S. patent application Ser. No. 12/803,311, filed Jun. 24, 2010.

### FIELD OF THE INVENTION

The invention relates to a system for supplying power to an electric vehicle on a parking space.

### BACKGROUND OF THE INVENTION

Electric vehicles, in particular electric cars, have recently attracted increased attention. Particularly due to the development of accumulator technology and the increasing prices of fossil fuels, vehicles with purely electric drive are an alternative to conventional vehicles. In this context, an increase in the registered electric vehicles is to be expected in the next few years.

In order to be able to operate such vehicles, charging stations are necessary which serve to supply power, specifically to charge the accumulators of these vehicles.

The present invention is based on the object of specifying a system for supplying power to an electric vehicle on a parking space, by means of which system the accumulators of an electric vehicle can be made possible while the vehicle stays on the parking space, for example on a parking space of a multistory car park, and the payment of the consumed power is easily made possible.

### BRIEF DESCRIPTION OF THE DRAWINGS

FIG. 1 illustrates an access control device for parking spaces of a parking area or a multistory car park and a vehicle associated therewith.

FIG. 2 illustrates a plurality of parking spaces provided with respective charging stations.

FIG. 3 illustrates a payment device for paying for consumed power, which can be integrated into the access control device or at other locations and includes a display.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

The present invention is based on the object of specifying a system for supplying power to an electric vehicle on a parking space, by means of which system the accumulators of an electric vehicle can be made possible while the vehicle stays on the parking space, for example on a parking space of a multistory car park, and the payment of the consumed power is easily made possible.

This object is achieved for a system for supplying power to an electric vehicle on a parking space wherein said system has, for each parking space or for a group of parking spaces, a charging station which is assigned to the parking space or the group of parking spaces and which comprises means for supplying power to the electric car, for detecting the consumed power, for identifying or detecting the vehicle for the purpose of billing for the consumed power, and a device for paying for the consumed power.

Further refinements and advantages according to the invention can be found in the original subclaims of the U.S. patent application Ser. No. 12/803,311, the disclosure of which is incorporated herein by reference.

Accordingly, a system for supplying power to an electric vehicle on a parking space is proposed, which system has, for each parking space or for a group of parking spaces, a charging station which is assigned to the parking space or the group of parking spaces and which comprises means for supplying power to the electric car, for detecting the consumed power and for identifying or detecting the vehicle for the purpose of billing for the consumed power.

The means for, supplying power to an electric car are preferably embodied as a cable which can be connected to a corresponding location on the vehicle or as devices for contactless charging of the accumulators of the vehicle, for example by induction

Furthermore, the system according to the invention comprises a device for paying for the consumed power, which device which can be integrated, for example, into an access control device for the parking space or for a multistory car park in which the parking space is provided

According to one preferred embodiment of the invention, the means for identifying or detecting the vehicle are embodied as RFID or NFC-enabled devices; in this context there is provision that the user of the electric vehicle which is to be provided with power activates the power supply by an RFID or NFC interaction between a mobile device, for example a mobile phone, and the means for identifying or detecting the vehicle after the vehicle has been parked on a parking space and after the means for supplying power to the vehicle have been connected.

In this context, the vehicle is detected or identified by means of a unique assignment number, for example by means of the mobile phone number, the number of the SIM card or using a number which is to be allocated during the RFID or NFC interaction and is stored in the mobile device or in the mobile phone. The power consumption is assigned to this number, so that, after the termination of the supplying of power, the user can pay when the parking space is exited by means of a renewed RFID or NFC interaction between his mobile device and the payment device using credit card data or bank connection data stored in the mobile device or mobile phone or using a direct payment by means of the telephone number of the mobile phone.

Alternatively, after the renewed RFID or NFC interaction, the amount to be paid can be displayed on a display of the payment device, wherein the payment can subsequently be made by means of a credit card or with cash. In this context, this can be done from the vehicle if the payment device is integrated into an access control device, which may be the case in a multistory car park. In order to implement the procedure described above, the consumption information and the unique assignment number of the vehicle are transferred to the payment device, directly or via a central server which is connected to the payment device, from the means for identifying or detecting the vehicle.

According to a further embodiment of the invention, after the supplying of power to the vehicle has ended, the amount corresponding to the power consumption can be transmitted to the portable device, for example in the form of a unidimensional or two-dimensional barcode by means of a renewed RFID or NFC interaction between the user's portable device or mobile phone and the RFID or NFC-enabled device. When the parking space or the multistory car park is exited, the bar code is read out by an RFID or NFC interaction between the portable device and the payment device or the access control device or by means of a scanning process, and the amount to be paid is displayed. The payment is subsequently carried out as described above. This variant of the invention advantageously avoids the connection of the charging station to a central server.

If the payment device is integrated into an access control device, for example into an access control device of a multistory car park when the multistory car park is exited the amount which is made up of the power consumption and the parking fees is displayed as the amount to be paid. The payment of the consumed power is therefore advantageously carried out in one step with the payment of the parking fees.

According to a further embodiment of the invention, the means for identifying or detecting the electric vehicle comprise a device for detecting the license plate of the vehicle, wherein the supplying of power can be activated after the license plate has been detected. In this context, when the parking space is exited, the vehicle is identified on the basis of the same device, or a further device, for detecting license plates, and the amount to be paid, which corresponds to the power consumption, is displayed on the payment device. The procedure for payment preferably corresponds to the procedure specified above.

If the device for paying for the power consumption is integrated into an access control device, which may be the case, for example, in a multistory car park, it is expedient that the vehicle is detected on traveling into the multistory car park by means of the device for detecting license plates. In this way, when the multistory car park is exited the parking fee and the fee for the power consumption can be paid simultaneously, i.e. in one step, on the basis of the renewed detection of the license plate.

In addition, according to a further embodiment of the invention, there may be provision that the means for identifying or detecting the vehicle comprise a device for setting up a wireless network connection, for example a WLAN device, which can set up a connection to a device for setting up a wireless network connection or a WLAN device of the vehicle or of a portable device, for example of a user's mobile phone, via which connection a unique assignment number, for example the license plate of the vehicle, the mobile phone number or the number of the SIM card of the mobile phone, can be transmitted to the means for identifying or detecting the vehicle, wherein the power consumption can be assigned to the assignment number which is used for billing for the power consumption. The wireless network connection can also be established, for example, using an UMTS network.

It is also possible to allocate, by means of a wireless connection, a unique number as the assignment number, which is stored in a computer of the vehicle or in the portable device or in the user's mobile phone and is used, when the parking space or the multistory car park is exited, to display the amount corresponding to the power consumption in order to permit payment. The supplying of power can be activated after the assignment number has been transmitted.

After the supplying of power has ended, the amount to be paid is determined when the parking space is exited on the basis of the assignment number by means of a wireless network connection or a WLAN connection between a computer of the vehicle or the user's mobile device or mobile phone and the payment device; said amount to be paid can be paid, for example, using credit card data or bank connection data stored in the computer of the vehicle or in the user's mobile device or mobile phone or using a direct payment by means of the telephone number of the mobile phone, wherein the consumption information and the unique assignment number of the vehicle are transmitted to the payment device, directly or via a central server which is connected to the payment device, from the means for identifying or detecting the vehicle.

In the case of a multistory car park, when the vehicle enters a multistory car park said vehicle is detected on the basis of an assignment number described above by means of a wireless network connection or WLAN connection which is to be set up between the vehicle or the user's portable device or mobile phone and an access control device, so that, when the multistory car park is exited, both the parking fees and the fees corresponding to the power consumption can be paid in one step.

According to one particularly preferred embodiment of the invention it is proposed, for the case in which the supply of power to the electric vehicle takes place via a cable which is to be connected to the vehicle, the cable is embodied in such a way that in addition to the power line a data line is also provided via which the data which are used for identifying or detecting the vehicle can be transmitted from a computer of the vehicle to the charging station. In this context, the license plate of the vehicle can be transmitted to the charging station through the cable, so that, when the parking space is exited, the sum which is to be paid can be displayed on the basis of detection of the license plate of the vehicle. It is also possible for the sum which corresponds to the power consumption to be paid using credit card data or bank connection data stored in the computer of the vehicle, by means of the cable through a corresponding operator control operation by the user.

As an alternative to the embodiment of the cable with a power line and a data line, it can also be provided according to the invention that the transmission of data from a computer of the vehicle to the charging station for identifying or detecting the vehicle and for transferring credit card data or bank connection data takes place via the power line of the cable.

According to a further embodiment of the present invention it is proposed that the means for identifying or detecting the electric vehicle which is to be supplied with power comprise a reading device for an RFID card or NFC card, a barcode card or for a magnetic card wherein the supplying of power is activated by reading in the card. The driver of the vehicle can receive this card, for example, from a suitable device of the charging station; in the case of a multistory car park, this card is preferably the parking ticket which the driver receives when he drives into the multistory car park.

According to one variant of the invention, the number of the card or further suitable data which are stored on the card are read out by the means for identifying or detecting the electric vehicle which is to be supplied with power, wherein, in order to determine the amount which is to be paid for the supply of power, the card is read in via the payment device, wherein the assignment of the power consumption to the vehicle is carried out on the basis of the card number or the further suitable data stored on the card.

In the case of a multistory car park, when the parking fee is paid at the automatic parking payment device or at an access control device which is arranged at the exit the power consumption is assigned to the vehicle on the basis of the number of the card or of the parking ticket or on the basis of the further suitable data stored on the card, and the sum of the parking fees and the fees for the consumed power is displayed for payment.

In order to avoid networking of the charging station with the automatic parking payment device or with an access control device, which may be necessary for the procedure described above, it is possible to provide that, after the supplying of power has ended, renewed interaction of the card with the reading device takes place, wherein in this case the reading device is also embodied as a writing device for an RFID or NFC card, a barcode card or a magnetic card. In this context, the amount which is to be paid for the power consumption is encoded on the card, so that the user of the vehicle can use the card to pay the fees corresponding to the power consumption at an automatic parking payment device or at an access control device when he leaves the parking space or the multistory car park, wherein in the case of a multistory car park the parking fees can also be paid simultaneously.

In addition, in order to simplify the detection of the vehicle and the payment of the power consumption, the charging station can have, as means for identifying or detecting the vehicle, a reading device for power supply authorizations which have already been prepaid, wherein the supplying of power is started and ended after the reading in of a prepaid power supply authorization if the amount corresponding to the power consumption corresponds to the prepaid amount or if the accumulators of the vehicle are completely charged.

In particular, the charging station can have, as means for identifying or detecting the vehicle, a reading device for prepaid cards, so that the supplying of power starts after the reading in of a prepaid card which can be embodied as an RFID or NFC card or as a magnetic card.

Instead of a prepaid card, it is also possible to use a mobile phone or a portable device on whose display a unidimensional or two-dimensional barcode, which corresponds to an already paid amount for the supplying of power, is displayed. The barcode can be read by a scanning device of the system for supplying power. The “power credit” can be obtained, for example, by means of an RFID or NFC interaction with a device of the charging station, with a device in a multistory car park or else by means of an Internet-based transaction.

The system presented here for supplying power to an electric vehicle on a parking space can be implemented in multistory car parks, in car parks of supermarkets, hotels, airports, sports stadiums and the like.

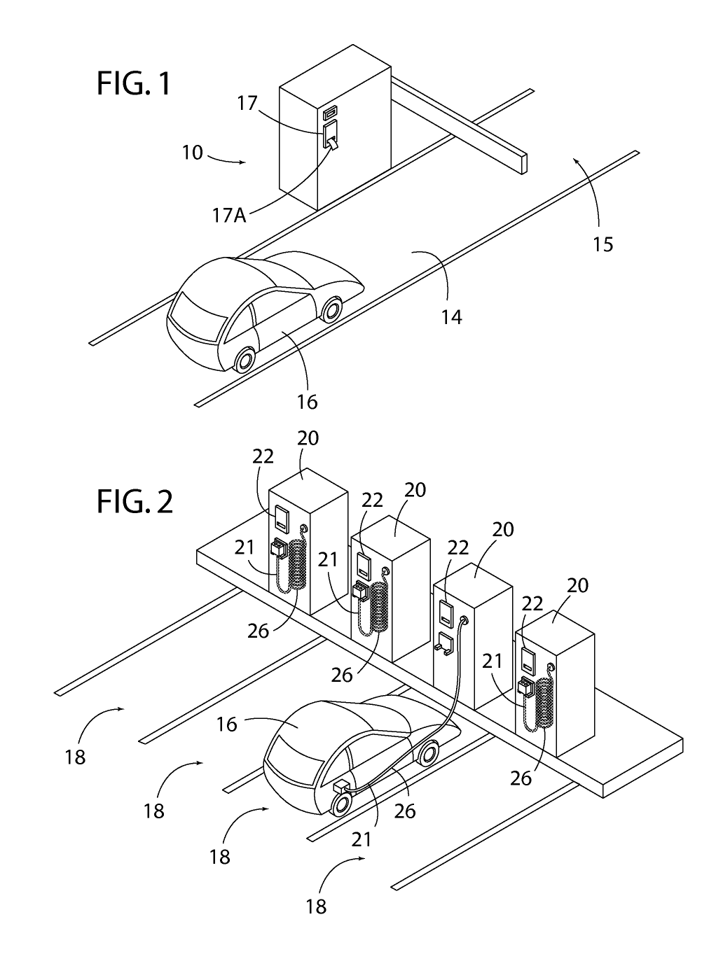

In a further aspect of the invention, FIG. 1 illustrates an access control device 10 that includes an openable gate 12 for controlling access through an entranceway 14 to a parking area 15, which may be a multistory car park. As such, a vehicle 16 can enter the parking area 15 as seen in FIG. 1. Preferably, the access control device 10 includes an identification device 17 for identifying entry of a particular vehicle. The identification device 17 can be a ticket dispenser that dispenses a parking ticket 17A to a driver of the vehicle 16. The identification device 17 may also be a card reader or other detection means which detects a unique card or other object associated with the user, such as a credit card, membership card or the like. As the vehicle enters, the identification device 17 creates a record of the entry time and at the least, allows the access control device 10 and parking system to calculate the parking fees for the vehicle's use of the parking area 15. Further, access control device 10 also can track any power consumption of the vehicle 16 happens to be an electric vehicle.

Referring to FIG. 2, the parking area 15 includes multiple parking spaces 18. With this system, the vehicle 16 is not assigned to any particular parking space 18, but instead may park at any available space 18 that is open.

For supplying power to an electric vehicle 16 on a parking space 18, said system has, for each parking space 18 or for a group of parking spaces 18, a charging station 20 which is assigned to the parking space 18 or the group of parking spaces 18 and which comprises power supply means 21 for supplying power to the electric car, detection means for detecting the consumed power, and an information reader 22, such as a ticket reader or card reader for the purpose of billing for the consumed power.

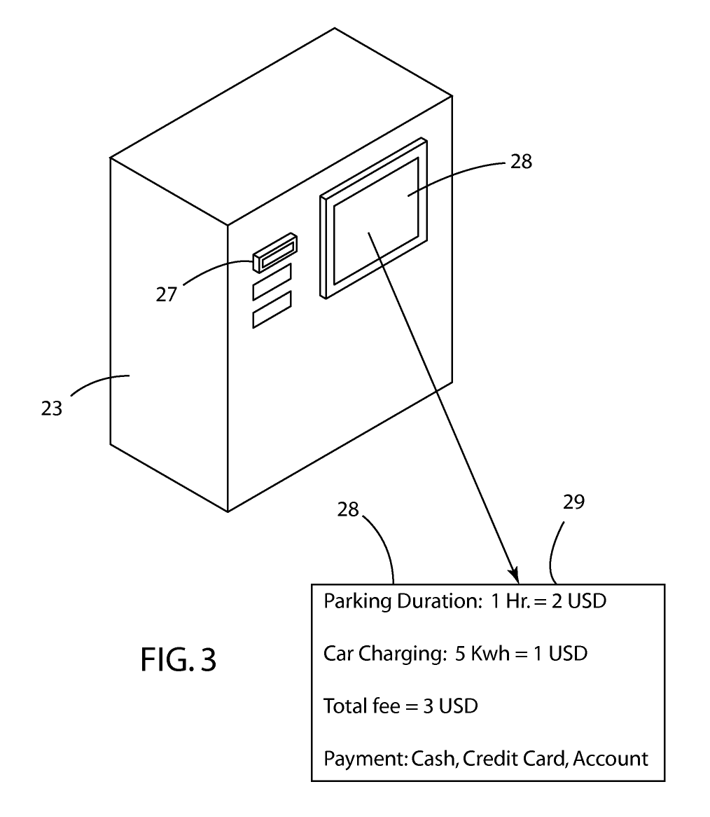

Referring to FIG. 3, the access control device 10 also includes a payment device 23 for paying for the consumed power as the vehicle 16 exits the parking area 15. This payment device 23 may be located at various locations such as a remote location within the parking area 15 that allows for prepayment of any fees before reaching the access control device 10, or at the exit location controlled by the access control device 10.

The power supply means 21 for supplying power to an electric car preferably is embodied as a cable 24 (FIG. 2), which can be connected to a corresponding location or plug on the vehicle 16. Alternatively, the power supply means 21 may be formed as a contactless charging device for contactless charging of accumulators, which optionally can be provided on the vehicle 16. The accumulators may be charged, for example, by induction.

In this embodiment of the invention, the identification device 17 may be a ticket dispenser, which issues or dispenses a ticket 17A to the driver of the vehicle 16 upon entry to the parking area through the entranceway 14. Typically, there is a parking fee for parking the vehicle 16, and where the vehicle 16 requires electric charging, a consumption fee or charging fee for the power consumed by the vehicle 16 during charging. If other identification is used, the identification device 17 will detect a unique identifier associated with the user so that the parking fees and power consumption fees can be tracked.

Further, a reader 22 can be provided at any place with a charger or charging station 20 as shown in FIG. 2 in order to associate the parking fee and the consumption fee for the power used for recharging the vehicle 16. The reader 22 may be a ticket reader which reads tickets 17A if issued, or a card reader which reads a card such as a credit card associated with the user. Before the charging station 20 will provide power, the user must actuate the reader 22 to provide the identifying information to the system. The charging station 20 and the access control device 10 may be networked so that the use information at the charger 20 is recorded against identifying information obtained upon entry.

Generally, the parking fees and consumption fees are associated to the same parking ticket 17A or other identifier detected by the reader 22 at the charging station 20, and these fees are paid through the payment device 23 when the user returns to the access control device 10 on an exit side thereof. The payment device 23 also may be located at other locations, and the fees could be paid before the vehicle 16 is picked up from its parking space 18. These fees are associated with the ticket 17A or other identifier when the user pays to exit the parking area 15.

More particularly where a ticket 17 is used, after the vehicle 16 is parked in a parking space 18, the ticket 17A is inserted within the ticket reader 22 and may be withdrawn or left in temporarily. The power supply means 21 such as cable 24 is connected to the vehicle 16 and if the ticket has been inserted within the ticket reader 22, charging can begin wherein power is supplied to the vehicle 16. After charging is complete, the power supply means 21 is disengaged from the vehicle 16, and the power consumed by the vehicle 16 is associated with the particular ticket 17A, such as by a unique identifier associated with such ticket 17A.

In one instance, the payment device 23 may allow the user to first pay the fees before retrieving the vehicle 15. At this stage, the parking payment machine or payment device 23 preferably asks or queries the charger 20 about the amount of power consumed for this parking ticket 17A and sums the power consumption fee with the parking fee. All of the consumed power is associated with the parking ticket 17A read by ticket reader 22 until a payment is made at the time of leaving the parking space 18 or until the charging cable 24 is unplugged. When asked for the power consumed by the vehicle 16 associated with a particular ticket 17A, the charger 20 stops its charging operation so that no further consumption fees are incurred. If desired, the user may decide to exit the parking area 15.

If the vehicle 16 is retrieved first, unplugging the cable 26 discontinues charging and associates termination of the power consumption with the user identification to calculate the consumption fees.

To prevent the charger 20 from being plugged into any neighboring cars which are not associated with the particular ticket 17A or user identification, once the cable 21 is plugged into the vehicle 15 and the charging step started, if the cable 24 is disconnected from the vehicle 15 and then reconnected to the same or a different vehicle 15 (meaning the charging current stops and restarts), then it is assumed the plug of the cable 24 has been unplugged and re-plugged possibly to charge another vehicle 15. Thus, when disconnection is detected, the charging is cancelled by the charging station 20 and the consumed amount memorized until payment. If the unplugging occurred legitimately, the user has the option to insert the particular parking ticket 17A back into the card reader 22 of the charging station 20. Inserting the ticket 17A again into the charging reader 22 (or another) then reauthorizes and detects the identifying information and restarts the charging process since reinsertion of the ticket 17A proves that the user is the authorized ticket owner. This situation might legitimately occur if the user unplugged the cable 24 for checking the cable 24 or for moving the user's vehicle 15 to another parking space 18. All power consumed by the vehicle in one or multiple charging cycles is charged to the particular ticket 17A or other identifier.

Referring to FIG. 3, the payment device 23 includes a reader 27, which reads the ticket 17A or other identifier such as credit card, and further includes a display 28 having a screen 29. The display screen 29 may show the parking duration and parking fee, the power consumption and consumption fee, the total fees due, and provide selections for paying such fees before the access control device 10 will permit passage of the vehicle 15. At the payment device 23, which typically is located at the exit, the ticket 17A or other card is inserted into the reader 27, read by the charging reader and then payment is made when leaving or before collecting the car to leave the parking.

Although particular preferred embodiments of the invention have been disclosed in detail for illustrative purposes, it will be recognized that variations or modifications of the disclosed apparatus, including the rearrangement of parts, lie within the scope of the present invention.

1. System for supplying power to an electric vehicle on a parking space, the system comprising for each parking space or for a group of parking spaces, a charging station which is assigned to the parking space or the group of parking spaces and which comprises power supply means for supplying power to the electric vehicle, power detection means for detecting consumed power which has been consumed by the vehicle, vehicle identification or detection means for identifying or detecting the vehicle for billing for the consumed power, and a payment device for paying for the consumed power, wherein the vehicle identification or detection means comprise an RFID or NFC-enabled device, wherein the power supply means can be activated by an RFID or NFC interaction between a mobile device or a mobile phone of a user of the vehicle and the vehicle identification or detection means, and wherein the vehicle can be detected or identified by means of the RFID or NFC interaction by means of a unique assignment number to which the consumed power is assigned and which serves for billing for the consumed power whereby the assignment number is a mobile phone number, a number of a SIM card of the mobile phone or a number which is to be allocated during the RFID or NFC interaction and is stored in the mobile device or in the mobile phone and wherein after termination of the supplying of power by the power supply means, the consumed power can be paid for when the parking space is exited by the vehicle by means of a renewed RFID or NFC interaction between the user's mobile device or mobile telephone and the payment device using credit card data or bank connection data stored in the mobile device or mobile phone or by a direct payment by means of the mobile phone number of the mobile phone, wherein the power consumption information and the unique assignment number of the vehicle are transferred to the payment device, directly or via a central server which is connected to the payment device, from the vehicle identification or detection means.

2-8. (canceled)

9. A system for controlling access to a parking area comprises:
an access control device which includes an identification device for detecting identifying information associated with a particular vehicle and allowing the access control device and system to calculate parking fees for the vehicle's use of the parking area and power consumption if such vehicle is an electric vehicle, said vehicle being parkable in any available parking space;
a charging station assigned to one or more parking spaces which comprises a power supply supplying power to and detecting consumed power by a vehicle, and an information reader for detecting said identifying information at said charging station in order to associate the parking fee and the consumption fee with the identifying information provided to said access control device, before the charging station will provide power, the user actuating the information reader to provide said identifying information to the charging station and after charging is complete, the power supply being disengaged from the vehicle wherein the power consumed by the vehicle is associated with the particular identifying information supplied to said access control device and said charging station.

10. The system according to claim 9, wherein said consumed power continues to be associated with the identifying information until a payment is made at the time of leaving the parking space or until the charging station is disconnected.

11. A method for controlling access to a parking area comprises:
providing an access control device which includes an identification device;
detecting identifying information associated with a particular vehicle and allowing the access control device and system to calculate parking fees for the vehicle's use of the parking area and power consumption if such vehicle is an electric vehicle, said vehicle being parkable in any available parking space;
supplying power to a vehicle by a charging station assigned to one or more parking spaces which comprises a power supply supplying power to and detecting consumed power by a vehicle;
before providing power, detecting said identifying information at said charging station in order to associate the parking fee and the consumption fee with the identifying information provided to said access control device;
before the charging station will provide power, the user actuating the information reader to provide said identifying information to the charging station; and
after charging is complete, disengaging the power supply from the vehicle wherein the power consumed by the vehicle is associated with the particular identifying information supplied to said access control device and said charging station.
